(19) United States
(12) Patent Application Publication
(10) Pub. No.: US 2005/0207707 A1
(43) Pub. Date: Sep. 22, 2005

(54) Nose assembly for optical device

(76) Inventor: Charles Hu, San Francisco, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/853,384

(22) Filed: May 25, 2004

Related U.S. Application Data
(60) Provisional application No. 60/553,770, filed on Mar. 17, 2004.

(51) Int. Cl. G02B 6/38; G02B 6/36

(52) U.S. Cl. 385/55; 385/54; 385/56; 385/62; 385/88; 385/92

(57) ABSTRACT

A nose assembly is provided for connecting the end of an optical fiber to an optical device (e.g., a transmitter). In one embodiment, the nose assembly includes a housing having a longitudinal bore formed therethrough and a fiber retaining assembly coupled to the longitudinal bore. Advantageously, the fiber retaining assembly can be secured to the housing primarily by friction fit, requiring no epoxy or other adhesive. In one embodiment, the fiber retaining assembly includes a tapered ring, a split sleeve ring, and a fiber stop. The back end of a portion of the housing, tapered ring, split sleeve ring and/or fiber stop can be constructed of stainless steel 304L so as to be weldable to an optical component, such as a packaging assembly.

### CROSS-REFERENCE TO RELATED APPLICATIONS

This application claims priority to and benefit from U.S. Provisional Patent Application Ser. No. 60/553,770, filed Mar. 17, 2004 and entitled “Nose Assembly for Optical Device.” This application is also related to U.S. patent application Ser. No. 10/832,699, filed Apr. 27, 2004 and entitled “Package for Optical Subassembly.” All of these applications are incorporated herein by reference in their entireties.

### BACKGROUND OF THE INVENTION

1. The Field of the Invention

Embodiments of the invention generally relate to optical fiber technology, and more specifically, to optical interconnection devices used to connect an optical fiber to an optical device or component.

2. The Relevant Technology

Optical fibers have generally replaced copper wire as the preferred medium for carrying telecommunications signals. As with copper wire, it is necessary to provide for the interconnection of optical fibers, during installation, repair, or replacement of the fibers, and to terminate the fibers onto active optical devices. Optical devices include, for example, optical switches, optical sensors, and transceivers. The termination of an optical fiber may be indirect, i.e., the fiber may be connected to some other (passive) optical device, such as a beam splitter or polarizer, before the optical signal is directed to the active optical device. The present invention is generally directed to an optical interconnection nose assembly for a termination of an optical fiber.

Manufacturing of optical interconnection nose assemblies generally requires a significant amount of time as a result of the time it takes to cure the components epoxied inside the assembly. An optical interconnection assembly generally includes a housing having one or more components therein, such as a fiber stop, ferrule-receiving sleeve, or securing bushing. Each component is generally secured to the housing using an epoxy. The securing epoxy takes some time to cure, and consequently, this curing time hinders the manufacturing process of optical interconnection nose assemblies and reduces the manufacturing throughput.

Therefore, a need exists for an easily manufactured, efficient, and cost effective optical interconnection nose assembly that overcomes the disadvantages of conventional optical interconnection nose assemblies.

### BRIEF SUMMARY OF THE INVENTION

An embodiment of the present invention is a nose assembly that includes a housing and a fiber retaining assembly. In one embodiment, the fiber retaining assembly may include a tapered ring fitted inside a back-end of the longitudinal channel, a split sleeve ring inside the tapered ring, and a fiber stop fitted inside the split sleeve ring. The split sleeve ring may be configured to hold the fiber stop in addition to the terminal end of the optical fiber. In operation, the split sleeve ring holds the terminal end of the optical fiber while the fiber stop abuts against the terminal end of the optical fiber. Generally, the fiber stop is aligned with the terminal end of the optical fiber such that an optical signal transmitted from the terminal end of the optical fiber passes through the fiber stop with minimal connection loss. A portion of the nose assembly can be constructed of stainless steel 304L so that the nose assembly can be weldable to an adjacent external component such as, but not limited to an optical packaging.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 shows a cross-sectional view of one embodiment of a nose assembly of the present invention; and

FIG. 2 shows a cross-sectional view of a nose assembly connected to an optical packaging assembly according to another embodiment of the invention.

### DETAILED DESCRIPTION OF A PREFERRED EMBODIMENT

I. Introduction

The following paragraphs provide details regarding embodiments of a nose assembly for an optical device, e.g., an optical transmitter. Although described and illustrated in the context of an optical transmitter, such nose assemblies may be used with various other optical devices, for example optical switches, optical sensors, receivers, and transceivers.

The nose assembly may be used to connect a terminal end of an optical fiber to an optical device. At a front end of the nose assembly, the assembly is configured to receive the terminal end of the optical fiber. At a back end, the assembly is configured to be connected to an optical device. While embodiments of the nose assembly are described below as connecting to an optical fiber and/or optical device, the optical fiber and optical device are not shown as they are not critical to the invention. It will be appreciated that any optical fiber configuration or any suitable optical device may be employed in conjunction with the nose assemblies described herein. Further, it will be appreciated that directional terms such as front and back are provided for illustration purposes only and are not to be limiting to the scope of the present invention.

The nose assembly includes a housing with a longitudinal channel formed through the housing. A fiber retaining assembly is configured to be disposed in the back end of the housing so as to be configured to receive the end of an optical fiber. In one embodiment, the fiber retaining assembly may include a tapered ring fitted inside a back-end of the longitudinal channel, a split sleeve ring inside the tapered ring, and a fiber stop fitted inside the split sleeve ring. The split sleeve ring may be configured to hold the fiber stop in addition to the terminal end of the optical fiber. In operation, the split sleeve ring holds the terminal end of the optical fiber while the fiber stop abuts against the terminal end of the optical fiber. Generally, the fiber stop is aligned with the terminal end of the optical fiber such that an optical signal transmitted from the terminal end of the optical fiber passes through the fiber stop with minimal connection loss.

II. An Exemplary Nose Assembly

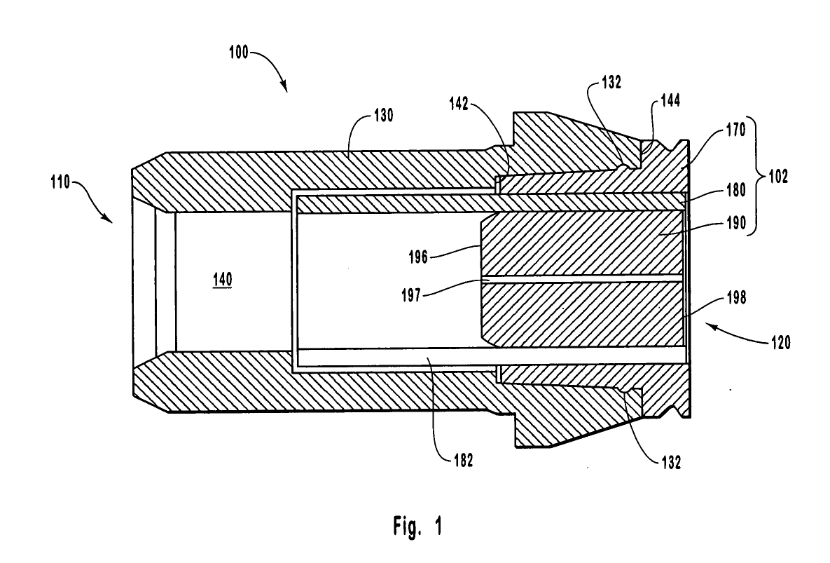

FIG. 1 illustrates a side cross sectional view of an exemplary nose assembly 100 incorporating features of the present invention. The nose assembly 100 has a front end 110 and a back end 120. The nose assembly 100 is generally configured to receive a terminal portion of an optical fiber at a front end 110 of the nose assembly 100. The back end 120 of assembly 100 is configured to couple to an optical device, such as, an optical switch, a transceiver, transmitter, and the like. The nose assembly 100 generally includes an elongated housing 130 having a longitudinal channel 140 formed therethrough. The longitudinal channel 140 has a front end that coincides with the front end 110 of the nose assembly 100 and a back end that coincides with the back end 120 of the nose assembly 100. The longitudinal channel 140 is generally shaped to hold one or more optical components. Generally, the longitudinal channel 140 has a diameter of about 2.5 mm, or 1.25 mm but may have any desired size. The housing 130 is made from a relatively hard material, for example 416 stainless steel. Other hard materials may be used such as metal or ceramic.

The nose assembly 100 may include one or more bushings (not shown) positioned proximate the front end 110, which are configured to cooperate with the nose assembly 100 to receive and hold the optical fiber therein. Similarly, at the back end 120 of the nose assembly 100, component may be provided to connect the back end to an optical device.

As shown in FIG. 1, the nose assembly 100 further includes a fiber retaining assembly 102 configured to be disposed in the back end 120 of the nose assembly 100. The fiber retaining assembly 102 is configured to be secured inside the housing 130 primarily by friction fit, as will be described further below. As such, no epoxy is required in order to assemble the nose assembly 100, thus greatly decreasing the manufacturing cost and time required to produce the nose assembly.

In one embodiment, shown in FIG. 1, the fiber retaining assembly 102 includes a tapered ring 170, a split sleeve ring 180, and a fiber stop 190 positioned near the back end 120 of the nose assembly 100. In one configuration, the tapered ring 170 can have an inner surface and/or an outer surface that is tapered. In one embodiment, the outer surface of tapered ring 170 is tapered at a 7 degree slope with respect to its longitudinal axis. That is, the portion of tapered ring 170 nearest the back end 120 of nose assembly 100 is slightly larger than the end nearest front end 110. In addition, the inner surface of the back end 120 of housing 130 can be slightly tapered to substantially the same degree as tapered ring 170. In other embodiments, the outer surface of tapered ring 170 is a slope of about 5 degrees to about 10 degrees. Other tapering configurations are possible. However, it is possible, although less desirable, that neither the inner surface or outer surface of tapered ring 170 is tapered. The tapered ring 170 is made from a material substantially softer than the housing 130, for example stainless steel 304L. However, other metals may be used to construct tapered ring 170, which metal is desirably softer than the material used to construct housing 130.

During manufacture of the nose assembly 100, the tapered ring 170 is disposed at the back end 120 of the assembly and pressed longitudinally into the housing 130. The tapered ring 170 may also be rotated in order to assist it in entering the housing 130. In one configuration, the housing 130 may have a smooth inner surface against which the tapered ring 170 presses. The outside diameter of tapered ring 170 can be formed slightly larger than the inside diameter of the housing 130. Because the material of the tapered ring 170 is softer than the material of the housing 130 the tapered ring deforms as it is pressed into housing 130 to tightly fit the tapered ring 170 within the housing 130.

In another embodiment, shown in FIG. 1, the housing 130 may include one or more small grooves 132 formed on the inside surface thereof where the surfaces of the housing and the tapered ring interface. Because the material of the tapered ring 170 is softer than the material of the housing 130, the tapered ring 170 desirably deforms as it is pressed into the housing 130. The small grooves 132 become filled with the deforming material of the tapered ring 170 as the pressing progresses.

Once the tapered ring 170 has been pressed into the housing 130 to its desired position, the engagement of the tapered ring 170 and the housing 130 results in a very strong friction fit between the housing 130 and the tapered ring 170. In the embodiment with housing 130 having small grooves 132, the deformed portion of tapered ring 170 disposed in grooves 132 can form an even tighter engagement therebetween so as to ensure that tapered ring 170 is secured in housing 130.

It will be appreciated that no epoxy is required to hold the tapered ring 170 against the inside portion of the housing 130. In order to facilitate press fitting the tapered ring 170 into the longitudinal channel 140, the longitudinal channel 140 can be generally shaped to receive the tapered ring 170. For example, the longitudinal channel 140 may be tapered or beveled so as to facilitate press-fitting the tapered ring 170 into the longitudinal channel 140. Alternatively, the front end of the tapered ring 170 may be tapered or beveled. The housing 130 may also include an inner ledge 142 and an outer ledge 144 formed on the channel 140. The inner ledge 142 is disposed nearer the front of the housing 130 than the outer ledge 144. The inner ledge 142 and the outer ledge 144 are configured to limit the tapered ring 170 from advancing too far into the longitudinal channel 140. As will be made clear in the following paragraphs, the tapered ring 170 is configured to hold the split sleeve ring 180 and the fiber stop 190.

Fitted against the inner surface of the tapered ring 170 is the split sleeve ring 180. The split sleeve ring 180 has an inner surface and an outer surface. The split sleeve ring 180 also includes a longitudinal slit 182 extending from the front end to the back end of the split sleeve ring 180. This is illustrated in FIG. 1 as one half of the cross section is taken along the slit 182. In other words, the split sleeve ring 180 includes a longitudinal section that has been removed so as to enable the split sleeve ring 180 to expand and contract according to the size of a component (e.g., fiber stop 190) contained inside the split sleeve ring 180.

During manufacture of the nose assembly 100, the outer surface of the split sleeve ring 180 is pressed against the inner surface of the tapered ring 170. This configuration operates to hold the split sleeve ring 180 inside the tapered ring 170 primarily by friction. In one embodiment, the outer diameter of the split sleeve ring 180 can be slightly larger than the inner diameter of the tapered ring 170. To enhance the friction fit, in one configuration, the split sleeve ring 180 can be formed to have a spring bias outward. During assembly, the split sleeve ring 180 can be contracted (due to the existence of slit 182) and inserted into tapered ring 170. After insertion, the split sleeve ring 180 can expand toward its spring bias so that it fits tightly against the tapered ring 170.

It will be appreciated that no epoxy is required to hold the split sleeve ring 180 against the inner surface of the tapered ring 170. In order to facilitate press fitting the split sleeve ring 180 into the tapered ring 170, the tapered ring 170 can be generally shaped to receive the split sleeve ring 180. For example, the tapered ring 170 may be tapered or beveled so as to facilitate press-fitting the split sleeve ring 180 into the tapered ring. Alternatively, the front end of the split sleeve ring 180 may be tapered or beveled.

Once the split sleeve ring 180 is disposed in tapered ring 170, it is desirable that the split sleeve ring 180 can expand to receive an optical fiber therein and then contract to secure the optical fiber inside the split sleeve 180. As such, the split sleeve ring 180 may be constructed from any material which performs these functions. For example, split sleeve ring 180 can be made from stainless steel, ceramic, beryllium copper, plastic, or any material with proper elastic deformation characteristics.

Although not shown, the split sleeve ring 180 is configured to receive and hold the terminal end of an optical fiber. The inside diameter of the split sleeve ring 180 may be slightly less than the outside diameter of the optical fiber to be received therein, so as to accommodate the optical fiber and firmly secure the optical fiber inside the split sleeve ring 180.

As shown in FIG. 1, the split sleeve ring 180 is configured to hold the fiber stop 190. The fiber stop 190 can be generally press-fitted against the inner surface of the split sleeve ring 180. The fiber stop 190 has an inner surface and an outer surface; the outer surface thereof is configured to press-fit against the inner surface of the split sleeve ring 180. To facilitate press fitting the fiber stop 190 into the split sleeve ring 180, the outer diameter of the fiber stop 190 can be slightly greater than the inner diameter of the split sleeve ring 180 so as to enable the split sleeve ring 180 to firmly secure the fiber stop 190 therein. The fiber stop 190 can, therefore, be held inside the split sleeve ring 180 primarily by friction.

It will be appreciated that no epoxy is required to hold or secure the fiber stop 190 against the inner surface of the split sleeve ring 180. In order to facilitate press fitting fiber stop 190 into the split sleeve ring 180, the split sleeve ring 180 can be generally shaped to receive the fiber stop 190. For example, the split sleeve ring 180 may be tapered or beveled so as to facilitate press-fitting the fiber stop 190 into the split sleeve ring. Alternatively, the front end of the fiber stop 190 may be tapered or beveled.

The fiber stop 190 (at its front end 196) is configured to stop a terminal end of an optical fiber such that the fiber stop 190 abuts against the terminal end of the optical fiber. The fiber stop 190 further includes a bore 197 configured for passing an optical signal transmitted from the terminal end of the optical fiber. The fiber stop 190 is generally aligned with the terminal end of the optical fiber, such that the optical signal from the terminal end of the optical fiber passes through the bore 197 with minimal connection loss, thus forming a low loss optical path. The back end 198 of fiber stop 190 may be angled, as illustrated in order to improve coupling of the optical signal.

In one embodiment, the solid tapered ring 170 disposed about the split sleeve ring 180 reinforces the split sleeve ring so that when nose assembly 100 is fully assembled, the fiber retaining assembly 102 automatically aligns the optic fiber (not shown) with the bore 197 of the fiber stop 190. In contrast in other conventional nose assemblies having non-solid tapered rings (e.g., a slit formed along the length of the tapered ring), causes the fiber retaining assembly 102 to contract or expand which can shifts the position of the optic fiber off-center.

III. Other Embodiments for the Nose Assembly

It will be appreciated that the fiber retaining assembly 102 does not have to include a separate tapered ring 170, split sleeve ring 180 and fiber stop 190. In one embodiment, the tapered ring 170 could be combined with the split sleeve ring 180 to form a tapered ring/split sleeve ring component. This combined component could have a longitudinal slit formed through the length therefore to provide the functions discussed above with respect to longitudinal slit 182. This combined component could be disposed in housing 130 primarily by friction fit as discussed above. In addition, the fiber stop 190 would then be disposed in the combined component as discussed above.

In another embodiment, the split sleeve ring 180 could be combined with the fiber stop 190 to form a split sleeve ring/fiber stop component. This combined component could have a longitudinal slit formed at least partially radially therethrough. The longitudinal slit would probably not extend all the way to the bore 197. The longitudinal slit would provide the functions discussed above with respect to longitudinal slit 182. The combined component would be disposed in the tapered ring 170 primarily by friction fit, which, in turn, is disposed in housing 130 primarily by friction fit as discussed above.

In still another embodiment, the tapered ring 170, split sleeve ring 180, and fiber stop 190 could be formed into an integral component (i.e., fiber retaining assembly) which is secured to the housing 130 primarily by friction fit.

In yet another embodiment, the fiber retaining assembly 102 could be formed from only a split sleeve ring 180 and fiber stop 190 without the tapered ring 170. The split sleeve ring 180 and fiber stop 190 could be disposed in the housing 130 primarily by friction fit as discussed above.

As can be seen, various embodiment of the fiber retaining assembly 102 are possible. Desirably, whatever embodiment is used performs both the function of retaining the end of an optical fiber, but also aligning the optical fiber with the bore 197 to allow optical communication between the optical fiber and the optical device to which the nose assembly 100 is attached.

Connection of the nose assembly 100 to an optical device can be made by various components connected to the back end of the housing 130 and/or the back end of the fiber retaining assembly 102.

IV. Forming an Optical Subassembly

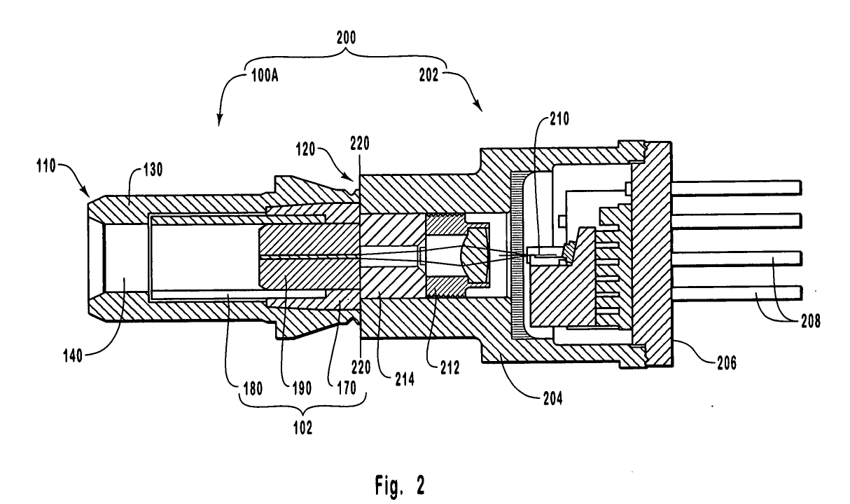

Turning now to FIG. 2, nose assembly 100 can be used to form an optical subassembly 200. As shown in FIG. 2, optical subassembly 200 includes nose assembly 100 connected to a packaging assembly 202. Packaging assembly 202 is one example of an optical component to which nose assembly 100 can be connected. For example, another optical component can be a printed circuit board. Since nose assembly 100 can be substantially similar to the embodiments described above, like elements will be referred to with like reference numbers.

The packaging assembly 202 includes a header can 204 connected to a header structure 206. The header structure 206 includes leads 208 extending outwardly therefrom. The header structure 206 includes an optical device 210 (e.g., a laser, photodiode, and the like). A lens 212 can be disposed in the header can as well as an isolator 214.

The header can 204 is connected to nose assembly 100 at interface 220. The back end of housing 130, tapered ring 170, split sleeve 180, and/or fiber stop portion 190 can be connected directly to header can 204. As such, the back end of housing 130, tapered ring 170, split sleeve 180, and/or fiber stop portion 190 may include at least a portion that is constructed of a material that is connected to header can 204 using means such as, but not limited to, welding, soldering and/or adhesive. In one embodiment, at least a portion of the back end of 130, tapered ring 170, split sleeve 180, and/or fiber stop portion 190 is formed from stainless steel 304L.

Significantly, it will be appreciated that header can 204 does not have to be shaped to be disposed in any particular structure in order to be connected to nose assembly 100. This reduces the step of having to shape header can 204 into any particular design. Thus, the header can 204 can be shaped in any design that allows the back end 120 of nose assembly 100 to abut the end of header can 204. As shown in FIG. 2, nose assembly 100 and header can 204 can be welded at interface 220 using laser welding. Other connecting means may be used including, but not limited to, soldering, adhesive, and the like. In addition, simple connecting means eliminate additional components that are required in order to connect header cans to nose assemblies. It will thus be appreciated that the present invention reduces the time and cost of manufacturing of optical subassemblies.

During assembly, front end 110 of nose assembly 100 will be connected to the terminal end of a fiber optic cable (not shown). Light to and/or from the end of the fiber optic cable (not shown) is transmitted through fiber stop 190 to the header can 204. Inside the header can 204, the light is transmitted to and/or from isolator 214 and, subsequently, to and/or from lens 212. Finally, light is transmitted from the lens 212 to and/or from the optical device located on the header structure 206. The header structure 206 converts the light signals into electrical signals and vice versa. The electrical signals are transmitted to and/or from a printed circuit board (not shown) via leads 208.

It is important to note that on contrast to the nose assembly 100 shown in FIG. 1, the nose assembly 100A shown in FIG. 2 shows housing 130 extending along the entire length of tapered ring 170. Thus, the back end of the housing 130 is able to abut the header can 204. It will be appreciated that the housing 130 could thus be formed of stainless steel 304 or other metal so as to be weldable to the header can 204. Indeed, any of the parts of the nose assembly 100 could be configured to be weldable to the header can 204.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

1. A nose assembly configured to connect at one end to an optical fiber and at the other end to an optical component, the assembly comprising:
a housing having a longitudinal channel formed therethrough, the housing having an inner surface, wherein the housing has a front end configured to receive an end of an optical fiber; and
a fiber retaining assembly having a front end configured to receive the end of the optical fiber and having a back end configured to be connected to an adjacent optical component by welding, wherein the back end of the fiber retaining assembly comprises steel 304L so as to be weldable to the optical component.

2. The nose assembly as recited in claim 1, wherein the fiber retaining assembly comprises an outer surface, wherein at least a portion of the outer surface of the fiber retaining assembly is secured to at least a portion of the inner surface of the housing primarily by friction fit.

3. The nose assembly as recited in claim 2, wherein at least a portion of the fiber retaining assembly is constructed of a material softer than that of the housing.

4. The nose assembly as recited in claim 2, wherein the longitudinal channel of the housing further comprises one or more grooves formed thereon.

5. The nose assembly as recited in claim 1, wherein the fiber retaining assembly comprises:
a tapered ring having an outside surface and an inside surface, wherein at least a portion of the outside surface of the tapered ring is configured to engage at least a portion of the inner surface of the housing primarily by friction fit;
a split sleeve ring having an outside surface and an inside surface, wherein at least a portion of the outside surface of the split sleeve ring is configured to engage at least a portion of the inner surface of the tapered ring primarily by friction fit; and
a fiber stop portion having an outside surface, wherein at least a portion of the outside surface of the fiber stop portion is configured to engage at least a portion of the inner surface of the split sleeve ring primarily by friction fit.

6. A nose assembly configured to connect at one end to the end of an optical fiber and at the other end to an optical device, the assembly comprising:
a housing having a longitudinal channel formed therethrough, the housing having an inner surface, wherein the housing has a front end configured to receive an end of an optical fiber; and
a fiber retaining assembly having a front end configured to receive the end of the optical fiber, the fiber retaining assembly comprising:
a tapered ring disposed in the longitudinal channel;
a split sleeve ring disposed in the tapered ring; and
a fiber stop portion disposed in the split sleeve ring,
wherein at least one of the tapered ring, split sleeve ring and fiber stop portion comprises steel 304L so as to be weldable to an adjacent optical component.

7. The nose assembly as recited in claim 6, wherein the at least one of the tapered ring, split sleeve ring and fiber stop portion.

8. The nose assembly as recited in claim 6, further comprising the tapered ring having an outside surface and an inside surface, wherein at least a portion of the outside surface of the tapered ring is configured to engage at least a portion of the inner surface of the housing primarily by friction fit.

9. The nose assembly as recited in claim 6, wherein at least a portion of the tapered ring is constructed of a material softer than that of the housing.

10. The nose assembly as recited in claim 6, further comprising the split sleeve ring having an outside surface and an inside surface, wherein at least a portion of the outside surface of the split sleeve ring is configured to engage at least a portion of the inner surface of the tapered ring primarily by friction fit.

11. The nose assembly as recited in claim 6, further comprising the fiber stop portion having an outside surface, wherein at least a portion of the outside surface of the fiber stop portion is configured to engage at least a portion of the inner surface of the split sleeve ring primarily by friction fit.

12. The nose assembly as recited in claim 6, wherein the longitudinal channel further comprises one or more grooves formed thereon.

13. The nose assembly as recited in claim 6, wherein the split sleeve ring includes a longitudinal slit formed along at least a portion of the outside surface thereof.

14. The nose assembly as recited in claim 6, wherein the longitudinal channel includes a first ledge formed near the front end thereof.

15. The nose assembly as recited in claim 6, wherein the fiber stop portion includes a longitudinal bore formed therethrough, the longitudinal bore being configured to align with the end of the optical fiber.

16. The nose assembly as recited in claim 6, wherein the fiber stop portion comprises a back end, wherein the back end of the fiber stop portion is angled.

17. The nose assembly as recited in claim 6, wherein the tapered ring comprises an outer surface and an inner surface, wherein at least one of the outer surface and the inner surface is tapered.

18. A nose assembly configured to connect at one end to an optical fiber and at the other end to an optical component, the assembly comprising:
a housing having a longitudinal channel formed therethrough, the housing having an inner surface, wherein the housing has a front end configured to receive an end of an optical fiber, wherein the back end of the housing comprises stainless steel 304L so as to be weldable to an adjacent optical component; and
a fiber retaining assembly having a front end configured to receive the end of the optical fiber.

19. The nose assembly as recited in claim 18, wherein the fiber retaining assembly comprises:
a tapered ring having an outside surface and an inside surface, wherein at least a portion of the outside surface of the tapered ring is configured to engage at least a portion of the inner surface of the housing primarily by friction fit;
a split sleeve ring having an outside surface and an inside surface, wherein at least a portion of the outside surface of the split sleeve ring is configured to engage at least a portion of the inner surface of the tapered ring primarily by friction fit; and
a fiber stop portion having an outside surface, wherein at least a portion of the outside surface of the fiber stop portion is configured to engage at least a portion of the inner surface of the split sleeve ring primarily by friction fit.

20. The nose assembly as recited in claim 18, wherein the longitudinal channel of the housing further comprises one or more grooves formed thereon.
